(19) United States
(12) Patent Application Publication
(10) Pub. No.: US 2009/0190835 A1
(43) Pub. Date: Jul. 30, 2009

(54) METHOD FOR CAPTURING IMAGE TO ADD ENLARGED IMAGE OF SPECIFIC AREA TO CAPTURED IMAGE, AND IMAGING APPARATUS APPLYING THE SAME

(75) Inventor: Chang-min LEE, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/190,055

(22) Filed: Aug. 12, 2008

(30) Foreign Application Priority Data
Jan. 29, 2008 (KR) 2008 9081

(51) Int. Cl. G06K 9/46

(52) U.S. Cl. 382/190

(57) ABSTRACT

An image capturing method and an imaging apparatus, the image capturing method including: selecting a face of a person from a captured image; enlarging the selected face; and adding the enlarged selected face to the captured image. Accordingly, it is possible for a user to simultaneously film people and their background more conveniently and economically.

### CROSS-REFERENCE TO RELATED APPLICATION

This application claims all benefits accruing under 35 U.S.C. §119 from Korean Application No. 2008-9081, filed Jan. 29, 2008, in the Korean Intellectual Property Office, the disclosure of which is incorporated herein by reference.

### BACKGROUND OF THE INVENTION

1. Field of the Invention

Aspects of the present invention relate to an image capturing method and an imaging apparatus using the method, and more particularly, to a method of capturing video of people, and an imaging apparatus using the method.

2. Description of the Related Art

Camcorders have become widespread, and are often used to capture performances or outdoor activities in which a plurality of people (such as a family) participates. When filming performances or outdoor activities in which a plurality of people participates, a photographer may focus either on the whole scene, or only on one specific person being photographed. If the photographer focuses on the whole scene, the face of the specific person being photographed is small, and it is impossible to capture details of the outward appearance of the person. In contrast, if the photographer focuses on the specific person being photographed, it is possible to show the outward appearance of the person in detail, but impossible to capture the entire scene.

Accordingly, in order to capture not only the details of a person's outward appearance but also the entire background, users have to use two camcorders, resulting in greater inconvenience. Additionally, buying camcorders may cause financial strain to users. Therefore, there is a need for methods by which a user may concurrently film people and their background more conveniently and economically.

### SUMMARY OF THE INVENTION

Several aspects and example embodiments of the present invention relate to an image capturing method for enlarging a specific image area of a captured image and adding the enlarged image to the captured image, so that the user may concurrently film people and their background more conveniently and economically, and to an imaging apparatus applying the same.

In accordance with an example embodiment of the present invention, there is provided a method of processing a captured image, the method including: selecting a specific image area from among the one or more detected image areas; enlarging the selected image area; and adding the enlarged image area to the captured image.

According to an aspect of the present invention, the method may further include detecting one or more image areas within the captured image.

According to an aspect of the present invention, the method may further include detecting a face of a person in the captured image, and the selecting may include selecting an image area containing the face of the person from the captured image.

According to an aspect of the present invention, the captured image may include faces of a plurality of people, and the selecting may include selecting the image area containing at least one face from among the faces.

According to an aspect of the present invention, the detecting may include continuously detecting the face contained in the selected image area in following frames of the captured image.

According to an aspect of the present invention, the method may further include storing the captured image to which the enlarged image is added separately from the captured image to which the enlarged image is not added.

According to an aspect of the present invention, the method may further include receiving a user setting of a position on the captured image to which the enlarged image is added.

According to an aspect of the present invention, the enlarging may include digitally zooming the selected image area.

In accordance with another example embodiment of the present invention, there is provided an imaging apparatus to capture an image and process the captured image, the imaging apparatus including: a control unit to receive a selection of a specific image area from the captured image; and an image processing unit to automatically add the enlarged specific image area to the captured image.

According to an aspect of the present invention, the image processing unit may automatically enlarge the selected image area.

According to an aspect of the present invention, the image processing unit may detect a face of a person in the captured image, and the control unit may receive a selection of the image area containing the face of the person from the captured image.

According to an aspect of the present invention, the captured image may include faces of a plurality of people, and the control unit may receive a selection of the image area containing at least one face from among the faces to be selected.

According to an aspect of the present invention, the image processing unit may continuously detect the face contained in the selected image area from following frames of the captured image.

According to an aspect of the present invention, the imaging apparatus may further include a storage unit to store the captured image to which the enlarged image is added separately from the captured image to which the enlarged image is not added.

According to an aspect of the present invention, the control unit may receive a user setting of a position on the captured image to which the enlarged image is added.

According to an aspect of the present invention, the image processing unit may enlarge the selected image area using digital zooming.

In accordance with yet another example embodiment of the present invention, there is provided a method of processing a captured image, the method including: selecting a specific image area from the captured image; and automatically adding the selected image area to the captured image.

In accordance with still another example embodiment of the present invention, there is provided an imaging apparatus to capture an image and process the captured image, the image apparatus including: a control unit to receive a selection of a specific image area from the captured image; and an image processing unit to add the selected image area to the captured image.

In accordance with another example embodiment of the present invention, there is provided a method of processing a captured image, the method including: detecting a specific image area within the captured image; and automatically adding the detected image area to the captured image.

Additional aspects and/or advantages of the invention will be set forth in part in the description which follows and, in part, will be obvious from the description, or may be learned by practice of the invention.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram of an imaging apparatus according to an example embodiment of the present invention;

FIG. 2 is a detailed block diagram of an image processing unit and a control unit, according to an example embodiment of the present invention;

FIG. 3 is a flowchart explaining a process of adding an enlarged image of a selected face to a captured image, according to an example embodiment of the present invention;

FIG. 4 illustrates a screen that enables the user to select a face from the captured image according to an example embodiment of the present invention;

FIG. 5 illustrates a screen on which the enlarged image of the selected image is displayed together with the captured image according to an example embodiment of the present invention; and

FIG. 6 illustrates screens on which the enlarged image continues to be displayed together with the captured image even after a facial image area has been selected, according to an example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

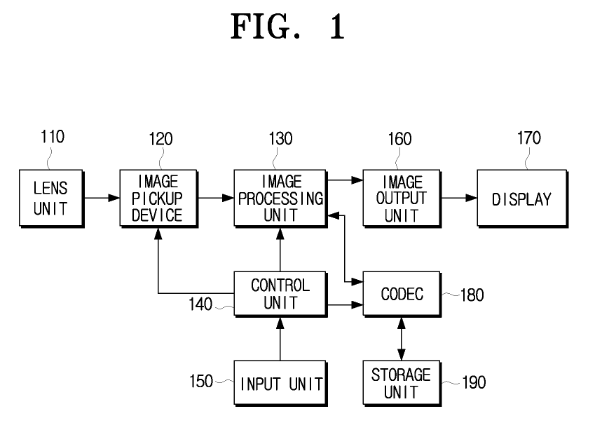

FIG. 1 is a block diagram of an imaging apparatus according to an example embodiment of the present invention. As an example, the imaging apparatus shown in FIG. 1 may be implemented as a camcorder. Referring to FIG. 1, the imaging apparatus includes a lens unit 110, an image pickup device 120, an image processing unit 130, a control unit 140, an input unit 150, an image output unit 160, a display 170, a CODEC 180 and a storage unit 190.

The lens unit 110 captures light from an object and forms an optical image of the captured area. The image pickup device 120 converts the light that enters through the lens unit 110 into an electric signal to generate an image signal (image), and performs predetermined signal processing on the electric signal. The image pickup device 120 includes pixels (such as a grid of pixels) and an analog-to-digital (A/D) converter. The pixels output analog image signals, and the A/D converter converts the analog image signals output from the pixels into digital image signals.

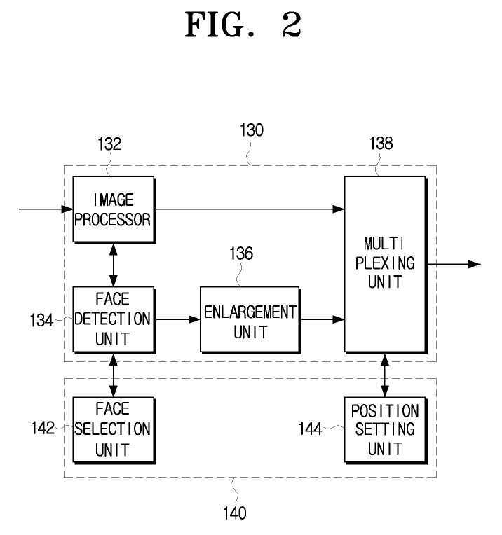

The image processing unit 130 performs signal processing on the image received from the image pickup device 120, and transmits the processed image signal so that the captured image may be displayed on the image output unit 160. The image processing unit 130 also outputs the processed image signal to the CODEC 180 in order to be stored. Specifically, the image processing unit 130 performs signal processing (such as digital zooming, automatic white balancing (AWB), automatic focus (AF), and automatic exposure (AE)) on the image output from the image pickup device 120, in order to convert the format of the image signal and/or adjust the image scale. Functions of the image processing unit 130 will be described in detail with reference to FIG. 2.

The image output unit 160 outputs the image signal received from the image processing unit 130 to a built-in display 170 or an external output terminal. The display 170 may display only the captured image, or display the captured image together with an enlarged image. In this example embodiment, the enlarged image includes a person's face selected by the user from the captured image and displayed in an enlarged state.

The CODEC 180 encodes the image signal output from the image processing unit 130, and transmits the encoded image signal to the storage unit 190. Additionally, the CODEC 180 decodes the encoded image signal stored in the storage unit 190, and transmits the decoded image signal back to the image processing unit 130. In other words, the CODEC 180 may perform encoding when the captured image is to be stored, and decoding when the stored image is to be output to the image processing unit 130. The storage unit 190 stores the image captured by the image pickup device 120 in a predetermined compression format. The storage unit 190 may be implemented as a volatile memory (such as RAM) or a non-volatile memory (such as ROM, flash memory, a hard disk drive, or a digital versatile disc (DVD)).

The input unit 150 receives user commands. The input unit 150 may, for example, be implemented as buttons on a surface of the imaging apparatus or as a touch screen on the display 170. Among the received commands, the input unit 150 receives a user command to select a face from among a plurality of faces appearing in the captured image, and a user setting of a position on the display 170 (or an external display device) on which the enlarged image is displayed. The control unit 140 controls the entire operation of the imaging apparatus. In more detail, the control unit 140 controls the image processing unit 130 to perform signal processing on the captured image, and controls the CODEC 180 to encode or decode the image signal.

Hereinafter, the image processing unit 130 and the control unit 140 will be described in detail with reference to FIG. 2. FIG. 2 is a block diagram of the image processing unit 130 and the control unit 140, according to an example embodiment of the present invention. Referring to FIG. 2, the image processing unit 130 includes an image processor 132, a face detection unit 134, an enlargement unit 136, and a multiplexing unit 138. The control unit 140 includes a face selection unit 142 and a position setting unit 144.

The image processor 132 performs signal processing on the captured image received from the image pickup device 120, and then transmits the processed image signal to the multiplexing unit 138 in order to add the enlarged image to the captured image. Additionally, the image processor 132 transmits the processed image signal to the face detection unit 134 so that the face detection unit 134 can detect a person's face in the captured image. That is, the face detection unit 134 detects at least one image including a face from the captured image. The face detection unit 134 may detect faces using a general face detection operation based on facial recognition. Specifically, the face detection unit 134 may perform face detection and/or facial recognition. Face detection is an operation to detect a face in the captured image, and facial recognition is an operation to recognize facial features in order to distinguish a face of a particular person from faces of other people. As an example, the face detection operation may be performed through color-based face detection, edge-based eye detection, face normalization, and support vector machine (SVM)-based face verification.

Color-based face detection is a method of detecting faces in an input image using skin color information. Specifically, this method generates a skin-color filter using YcbCr information of the input image, and extracts facial areas from the input image. Accordingly, color-based face detection causes only skin-color areas to be extracted from the input image. Additionally, edge-based eye detection is a technique to detect eyes using gray level information. It is possible to easily isolate eye areas generally, but false detection errors may occur due to subjects having variable hairstyles or eyeglasses. Face normalization is performed to normalize facial areas using the detected eye areas. Additionally, the normalized facial areas are verified through the SVM-based face verification. If the SVM-based face verifier is used, false face detection performance can be reduced to less than 1%. The face detection unit 134 may detect faces in the captured image through the aforementioned processes.

Facial recognition implemented by the face detection unit 134 may include holistic processes and/or analytic processes. Holistic processes result in facial recognition based on the features of the entire facial area. Furthermore, holistic processes use the eigenface technique and template matching-based technique. Analytic processes result in facial recognition by extraction of the geometric features of faces. Analytic processes enable rapid recognition and require a small memory capacity, but have difficulties in selecting and extracting the facial features.

According to aspects of the present invention, facial recognition is performed through the following operations. First, the face detection unit 134 receives an image including a face, and then extracts facial components (for example, eyes, nose or mouth) from the image. Subsequently, the face detection unit 134 performs image compensation when a face is rotated or when lighting is enabled. Accordingly, the face detection unit 134 may extract the facial features from the image, so that the person's face can be detected. The face detection unit 134 may detect the whole face pattern from the captured image, and may then detect the face in the image using the detected face pattern.

The enlargement unit 136 enlarges an image area including a face selected by the user using a digital zooming process in order to obtain an enlarged image. The multiplexing unit 138 adds the enlarged image output from the enlargement unit 136 to the captured image output from the image processor 132.

The face selection unit 142 allows the user to select one of a plurality of faces appearing in the captured image. Specifically, the face selection unit 142 allows the user to select one of the faces detected by the face detection unit 134. The face selection unit 142 also controls the face detection unit 134 to output the image area including the selected face to the enlargement unit 136.

The position setting unit 144 controls the multiplexing unit 138 so that the enlarged image is added to a position on the captured image set by the user. In more detail, the position setting unit 144 receives information regarding the position in order to add the enlarged image, and then controls the multiplexing unit 138 so that the enlarged image is added to the set position on the captured image. The image processing unit 130 and the control unit 140 may thus add the enlarged image obtained by enlarging the selected face, to the captured image.

The image processing unit 130 continues to detect the face that has already been selected by the user from following frames. Accordingly, the user is able to continuously view the face, which is selected once, as an enlarged image.

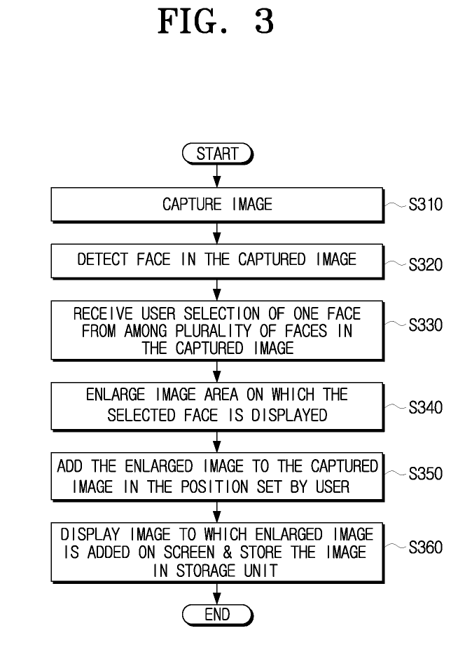

Hereinafter, a process of adding an enlarged image of a selected face to a captured image will be described with reference to FIG. 3. FIG. 3 is a flowchart illustrating a process of adding an enlarged image of a selected face to a captured image, according to an example embodiment of the present invention.

Referring to FIG. 3, the imaging apparatus captures an image in operation S310. The image processing unit 130 detects faces in the captured image in operation S320. Specifically, the image processing unit 130 detects one or more of a plurality of faces appearing in the captured image, and temporarily stores the detected faces in a memory.

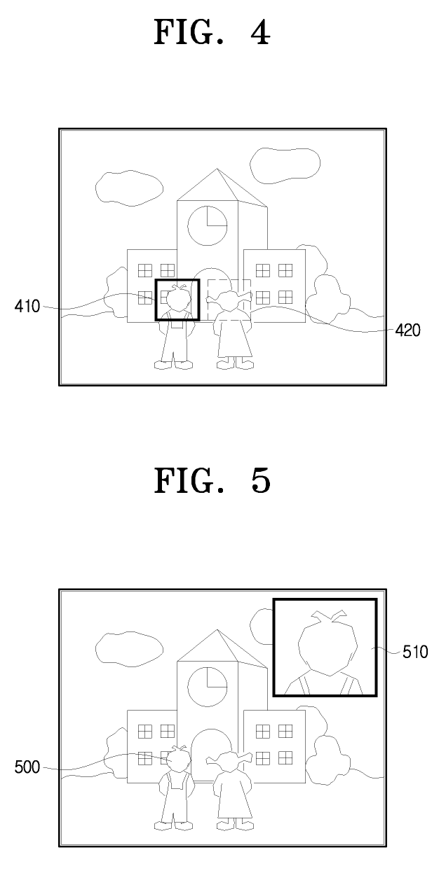

The control unit 140 receives a user selection of one face from among the one or more detected faces on the captured image in operation S330. A screen through which the user is able to select a face from the captured image will now be described with reference to FIG. 4. FIG. 4 illustrates a screen that enables the user to select a face from the captured image according to an example embodiment of the present invention. Referring to FIG. 4, a captured image being displayed on the display 170 (or an external display) includes a first person, a second person, a first face box 410 and a second face box 420. The first face box 410 and the second face box 420 are indicated by a solid line and a dashed line, respectively, and contain faces of the corresponding person. Additionally, the user may select a face that the user desires to acquire as an enlarged image using the input unit 150.

Highlighting is displayed on four sides of the first face box 410, so it is determined that the user desires to enlarge the face of the first person. As described above, since faces detected from the captured image are indicated by dashed lines, the user may easily check which face is detected by the imaging apparatus. Additionally, the user may select a face that the user desires to enlarge while moving the highlighting. However, it is understood that aspects of the present invention are not limited to face boxes, solid lines, and dashed lines to indicate a detected face. For example, according to other aspects, the detected faces may be circled with a line have a first color, while the selected face is circled with a line having a second color different from the first color.

Referring back to FIG. 3, the image processing unit 130 enlarges an image area on which the selected face is displayed in operation S340, and then adds the enlarged image to the captured image so that the enlarged image is disposed (e.g., superimposed) in a position set by the user in operation S350.

Subsequently, the control unit 140 controls the image containing the enlarged image to be displayed on the display 170 in operation 360. Additionally, the control unit 140 controls the image containing the enlarged image to also be stored in the storage unit 190 in operation S360. In this situation, according to the control of the control unit 140, the image containing the enlarged image may be stored in the storage unit 190 separately from the original captured image.

After the above processes are performed, the enlarged image 510 of the selected face is displayed together with the captured image on a single screen as shown in FIG. 5. FIG. 5 illustrates a screen on which the enlarged image 510 of the selected face is displayed together with the captured image according to an example embodiment of the present invention. Referring to FIG. 5, the enlarged image 510 obtained by enlarging a face of a first person 500 is displayed on top of the captured image on the display 170. Accordingly, the user is able to simultaneously capture people's faces and the whole background.

Additionally, the enlarged image 510 is displayed on the upper right of the screen, though the user may change the position of the enlarged image 510. That is, the user may set the position of the enlarged image 510 so that the enlarged image 510 is displayed on the lower left of the screen, or any other position on the screen.

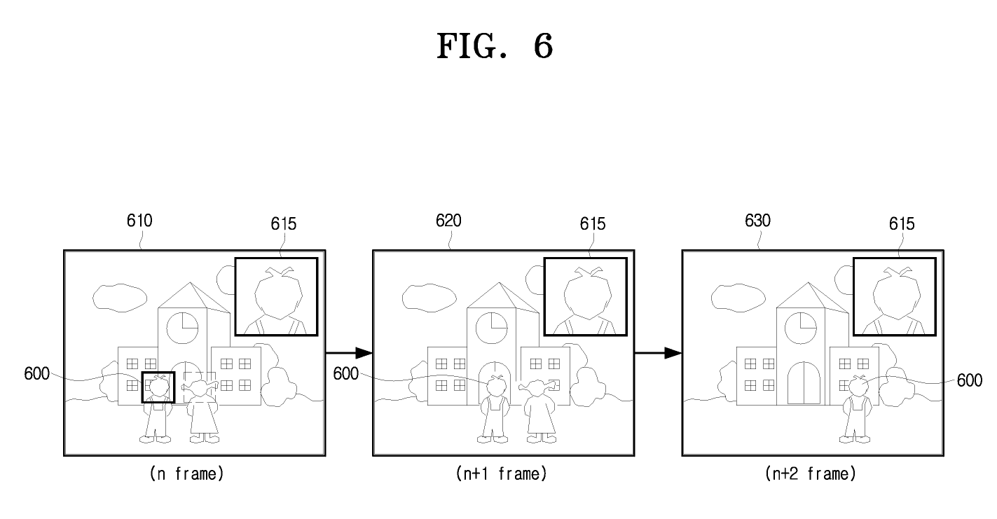

Hereinafter, the following frames to be displayed after the face is selected will be described with reference to FIG. 6. FIG. 6 illustrates screens on which the enlarged image continues to be displayed on top of the captured image even after the facial image area has been selected, according to an example embodiment of the present invention. Referring to FIG. 6, a first screen 610 displays a first person and a second person, and an enlarged image window 615. The enlarged image window 615 shows an enlarged image obtained by enlarging a face 600 of the first person selected by the user. The first screen 610 corresponds to an n-th frame, and is displayed when the user selects the face 600 from the n-th frame.

As the user selects the face 600, the enlarged image 615 of the face 600 continues to be displayed on the following frames. Accordingly, a second screen 620 corresponds to an (n+1)-th frame in which the face 600 moves slightly to the right. Even when the face 600 moves slightly to the right, the enlarged image of the face 600 is displayed on the enlarged image window 615.

A third screen 630 corresponds to an (n+2)-th frame, in which the face 600 moves significantly to the right. However, the enlarged image of the face 600 is also displayed on the enlarged image window 615 on the third screen 630 without change.

Therefore, if the user selects the face appearing in the captured image once, the selected face may be continuously extracted from the following scenes, and may thus be displayed as an enlarged image. Accordingly, the user is able to select a face that he or she desires to enlarge, so it is possible for the user to film the whole background together with an enlarged image in which the selected face is enlarged.

While the selected face is enlarged and displayed as an enlarged image in the example embodiment of the present invention, the selected face may be displayed on an additional display window without being enlarged in other embodiments of the present invention. Additionally, while a camcorder may be used as an imaging apparatus according to the example embodiment of the present invention, aspects of the present invention are equally applicable to any apparatus capable of photographing images (for example, a digital single lens reflex (DSLR) camera, or a mobile phone camera). Furthermore, the images may be still images or video images.

As described above, according to aspects of the present invention, a specific image area selected from the captured image may be enlarged and added to the captured image. Accordingly, the user may simultaneously film people and their background more conveniently and economically. Additionally, faces may be detected from the captured image and the detected faces may be enlarged and displayed, so it is possible to simultaneously film the whole background and details of people's outward appearances.

Aspects of the present invention can also be embodied as computer-readable codes on a computer-readable recording medium. Also, codes and code segments to accomplish the present invention can be easily construed by programmers skilled in the art to which the present invention pertains. The computer-readable recording medium is any data storage device that can store data which can be thereafter read by a computer system or computer code processing apparatus. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, more than one image area may be selected, enlarged, and added to the captured image, or the selected image area may not be enlarged. Furthermore, multiple keywords may be applied to one icon. Accordingly, it is intended, therefore, that the present invention not be limited to the various example embodiments disclosed, but that the present invention includes all embodiments falling within the scope of the appended claims.

What is claimed is:

1. A method of processing a captured image, the method comprising:
selecting a specific image area from among the one or more detected image areas;
enlarging the selected specific image area; and
adding the enlarged specific image area to the captured image in order to simultaneously display and/or capture the entire captured image and the enlarged specific image area.

2. The method as claimed in claim 1, further comprising:
detecting one or more image areas within the captured image.

3. The method as claimed in claim 2, wherein:
the detecting of the one or more images areas comprises detecting one or more faces of one or more people in the captured image; and
the one or more detected image areas each comprise at least one corresponding detected face.

4. The method as claimed in claim 3, wherein:
the captured image comprises faces of a plurality of people; and
the selecting of the specific image area comprises selecting the specific image area containing the at least one corresponding detected face from among the faces.

5. The method as claimed in claim 3, wherein the detecting of the one or more image areas further comprises continuously detecting the corresponding face contained in the selected specific image area in following frames of the captured image.

6. The method as claimed in claim 1, further comprising storing the captured image to which the enlarged image is added separately from the captured image to which the enlarged image is not added.

7. The method as claimed in claim 1, further comprising receiving a user setting of a position on the captured image to which the enlarged image is added.

8. The method as claimed in claim 1, further comprising displaying the captured image to which the enlarged image is added.

9. The method as claimed in claim 8, wherein the displaying of the captured image comprises continuously displaying the captured image to which the enlarged image is added in following frames of the captured image.

10. The method as claimed in claim 2, wherein the detecting of the one or more image areas comprises:
detecting one or more image areas within the captured image using face detection operations that detect the one or more faces in the captured image and/or facial recognition operations that recognize facial features of the one or more faces.

11. The method as claimed in claim 1, wherein the adding of the enlarged specific image area to the captured image comprises adding the enlarged specific image area to the captured image in future frames while the image is being captured.

12. An imaging apparatus to capture an image and process the captured image, the imaging apparatus comprising:
a control unit to receive a selection of a specific image area from the captured image; and
an image processing unit to automatically add the enlarged specific image area to the captured image in order to simultaneously display and/or capture the entire captured image and the enlarged specific image area.

13. The imaging apparatus as claimed in claim 12, wherein:
the image processing unit to automatically enlarge the selected image area.

14. The imaging apparatus as claimed in claim 12, wherein:
the image processing unit detects one or more image areas within the captured image;
and the control unit receives the selection of the specific image area from among the one or more detected image areas.

15. The imaging apparatus as claimed in claim 14, wherein the image processing unit detects the one or more image areas by detecting one or more faces of one or more people in the captured image, and the one or more detected image areas each comprise at least one corresponding detected face.

16. The imaging apparatus as claimed in claim 15, wherein:
the captured image comprises faces of a plurality of people; and
the control unit receives the selection of the specific image area containing the at least one corresponding detected face from among the faces of the plurality of people.

17. The imaging apparatus as claimed in claim 15, wherein the image processing unit continuously detects the corresponding face contained in the selected specific image area in following frames of the captured image.

18. The imaging apparatus as claimed in claim 12, further comprising a storage unit to store the captured image to which the enlarged image is added separately from the captured image to which the enlarged image is not added.

19. The imaging apparatus as claimed in claim 12, wherein the control unit receives a user setting of a position on the captured image to which the enlarged image is added.

20. The imaging apparatus as claimed in claim 12, further comprising a display unit to display the captured image to which the enlarged image is added.

21. The imaging apparatus as claimed in claim 20, wherein the display unit continuously displays the captured image to which the enlarged image is added in following frames of the captured image.

22. The imaging apparatus as claimed in claim 15, wherein the image processing unit detects the one or more image areas within the captured image using face detection operations that detect the one or more faces in the captured image and/or facial recognition operations that recognize facial features of the one or more faces.
